(19) United States
(12) Patent Application Publication
(10) Pub. No.: US 2024/0378819 A1
(43) Pub. Date: Nov. 14, 2024

(54) VALIDATING AND FILTERING MIXED REALITY CONTENT

(71) Applicant: International Business Machines Corporation, Armonk, NY (US)

(72) Inventors: Jeremy R. Fox, Georgetown, TX (US); Fang Lu, Billerica, MA (US); Tushar Agrawal, West Fargo, ND (US); Sarbajit K. Rakshit, Kolkata (IN)

(21) Appl. No.: 18/315,575

(22) Filed: May 11, 2023

(51) Int. Cl. G06T 19/00; G06T 5/20

(52) U.S. Cl. CPC G06T 19/006; G06T 5/20; G06T 19/003

(57) ABSTRACT

In an approach to validating and filtering mixed reality content, one or more computer processors receive a request for mixed reality content from a user. One or more computer processors retrieve the mixed reality content. One or more computer processors determine a mobility of the user in a physical environment. One or more computer processors determine the mixed reality content does not comply with at least one pre-defined policy associated with a physical location boundary within the physical environment. One or more computer processors filter the mixed reality content to comply with the at least one pre-defined policy. Based on the mobility of the user in the physical environment, one or more computer processors process the filtered mixed reality content. One or more computer processors display the filtered mixed reality content.

### BACKGROUND OF THE INVENTION

The present invention relates generally to the field of mixed reality, and more particularly to validating and filtering mixed reality content.

Mixed reality (MR) is a term used to describe the merging of a real-world environment and a computer-generated one. Physical and virtual objects may co-exist in mixed reality environments and interact in real time. MR technology enables real and virtual elements to interact with one another and enables the user to interact with virtual elements as they would in the real-world. MR may not be considered a fully immersive experience since it maintains a connection to the real world. In a mixed reality environment, wherever a user focuses attention, while wearing MR technology, the 3D content that the user encounters in the space reacts to the user as it would in the real-world. For example, a virtual object will move closer to the user as the user moves closer to it, and the user can interact with the object, e.g., the user can turn an object using gestures.

Edge computing is a recent trend that extends cloud computing and the Internet of Things (IoT) to the edge of the network, bringing more computational power and resources closer to end users by increasing the number of endpoints and positioning them nearer to consumers, be they users or devices. Edge computing is a distributed computing paradigm that brings computation and data storage closer to the sources of data. This is expected to improve response times and save bandwidth. Edge computing is an architecture rather than a specific technology, and a topology- and location-sensitive form of distributed computing. Edge computing architectures are based on existing technologies and distributed systems paradigms, providing a range of well-understood components to create the most effective architectures for delivering edge use cases.

In any MR interaction taking place in a physical environment, such as an office building or activity floor, a user can interact with virtual reality (VR) objects. However, if these objects contain malicious content or misleading information, or the MR system is hacked, the user may be misled into performing an incorrect action. To prevent this, it is necessary to develop a method and system for validating MR content according to the policy of the physical environment at the edge and for IoT environments.

### SUMMARY

A first aspect of the present invention discloses a computer-implemented method including one or more computer processors receiving a request for mixed reality content from a user. One or more computer processors retrieve the mixed reality content. One or more computer processors determine a mobility of the user in a physical environment. One or more computer processors determine the mixed reality content does not comply with at least one pre-defined policy associated with a physical location boundary within the physical environment. One or more computer processors filter the mixed reality content to comply with the at least one pre-defined policy. Based on the mobility of the user in the physical environment, one or more computer processors process the filtered mixed reality content. One or more computer processors display the filtered mixed reality content. The present invention has the advantage of acting as a security layer and ensuring the mixed reality content is in compliance with security policies.

A second aspect of the present invention discloses a computer program product including one or more computer readable storage media and program instructions to receive a request for mixed reality content from a user. The program instructions include program instructions, stored on at least one of the one or more computer-readable storage media, to retrieve the mixed reality content. The program instructions include program instructions, stored on at least one of the one or more computer-readable storage media, to determine a mobility of the user in a physical environment. The program instructions include program instructions, stored on at least one of the one or more computer-readable storage media, to determine the mixed reality content does not comply with at least one pre-defined policy associated with a physical location boundary within the physical environment. The program instructions include program instructions, stored on at least one of the one or more computer-readable storage media, to filter the mixed reality content to comply with the at least one pre-defined policy. Based on the mobility of the user in the physical environment, the program instructions include program instructions, stored on at least one of the one or more computer-readable storage media, to process the filtered mixed reality content. The program instructions include program instructions, stored on at least one of the one or more computer-readable storage media, to display the filtered mixed reality content.

A third aspect of the present invention discloses a computer system including one or more computer processors one or more computer-readable memories and one or more computer readable storage media and program instructions, stored on at least one of the one or more computer readable storage media for execution by at least one of the one or more computer processors via at least one of the one or more memories, to receive a request for mixed reality content from a user. The program instructions include program instructions, stored on at least one of the one or more computer-readable storage media, to retrieve the mixed reality content. The program instructions include program instructions, stored on at least one of the one or more computer-readable storage media for execution by at least one of the one or more computer processors via at least one of the one or more memories to determine a mobility of the user in a physical environment. The program instructions include program instructions, stored on at least one of the one or more computer-readable storage media for execution by at least one of the one or more computer processors via at least one of the one or more memories to determine the mixed reality content does not comply with at least one pre-defined policy associated with a physical location boundary within the physical environment. The program instructions include program instructions, stored on at least one of the one or more computer-readable storage media for execution by at least one of the one or more computer processors via at least one of the one or more memories to filter the mixed reality content to comply with the at least one pre-defined policy. Based on the mobility of the user in the physical environment, the program instructions include program instructions, stored on at least one of the one or more computer-readable storage media for execution by at least one of the one or more computer processors via at least one of the one or more memories to process the filtered mixed reality content. The program instructions include program instructions, stored on at least one of the one or more computer-readable storage media for execution by at least one of the one or more computer processors via at least one of the one or more memories to display the filtered mixed reality content.

In another aspect, the present invention discloses where the mobility of the user in the physical environment includes at least one of a location coordinate, a relative position of the user, and whether the user is moving from one physical location to another. An advantage of tracking the mobility of the user in the physical environment enable is that it enables edge devices in the environment to collaborate with each other regarding which instance of the present invention maintains control of the mixed reality content validation.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a mixed reality content control system, on an edge device within the distributed data processing environment of FIG. 1, for validating and filtering mixed reality content, in accordance with an embodiment of the present invention; and

FIG. 3 illustrates an exemplary computer environment in which aspects of one or more of the illustrative embodiments may be implemented, and at least some of the computer code involved in performing the inventive methods may be executed, in accordance with an embodiment of the present invention.

### DETAILED DESCRIPTION

Embodiments of the present invention recognize that computing security may be improved by providing a mixed reality (MR) control system on a plurality of edge devices within a physical environment that connect with an MR device and validate MR content prior to displaying the content to prevent malicious content and/or misleading information from being presented to a user. Embodiments of the present invention also recognize that additional computing security may be gained by filtering the MR content based on one or more pre-defined policies associated with each edge device in the physical environment prior to projecting the content for the user. Additionally, embodiments of the present invention recognize that efficiency may be gained by adapting the MR content to the location and mobility of the user in the space. By utilizing edge computing among edge devices, one skilled in the art would recognize that the bandwidth associated with utilizing a centralized server or a cloud computing system is reduced. In addition, the security of information obtained by the edge devices is improved because unnecessary or inappropriate information can be filtered near the source. Implementation of embodiments of the invention may take a variety of forms, and exemplary implementation details are discussed subsequently with reference to the Figures.

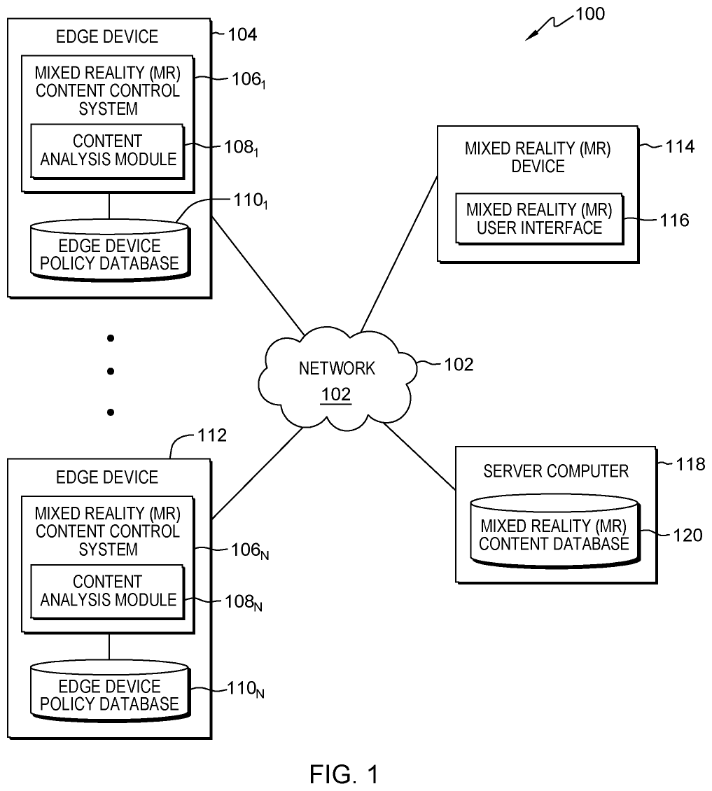

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

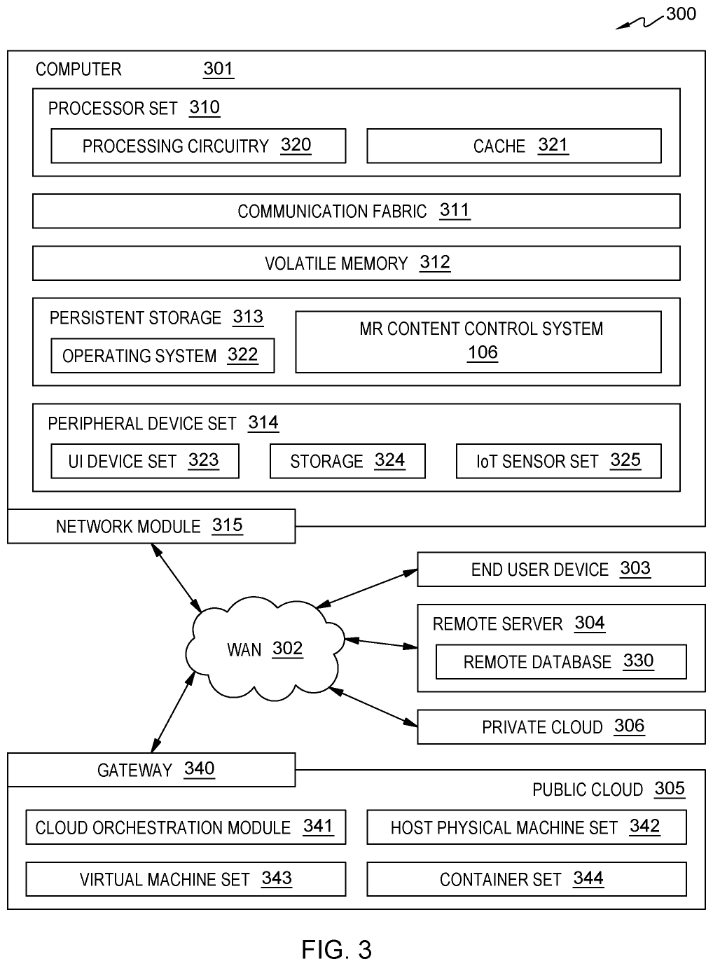

Distributed data processing environment 100 includes edge device 104, edge device 112, MR device 114, and server computer 118, all interconnected over network 102. In an embodiment, distributed data processing environment 100 represents an edge computing ecosystem in a physical environment. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between edge device 104, edge device 112, MR device 114, server computer 118, and other computing devices (not shown) within distributed data processing environment 100. Distributed data processing environment 100 may be implemented in computing environment 300, shown in FIG. 3.

Edge device 104 and edge device 112 represent an array of edge devices located within a physical environment and can each be one or more of a laptop computer, a tablet computer, a smart phone, smart watch, a smart speaker, manufacturing equipment, or any programmable electronic device capable of communicating with various components and other computing devices (not shown) within distributed data processing environment 100, via a network, such as network 102. In general, edge device 104 and edge device 112 each represents one or more programmable electronic devices or combination of programmable electronic devices capable of executing machine readable program instructions. Edge device 104 and edge device 112 can each be static or mobile. For example, edge device 104 and edge device 112 may each be a mobile device, such as a camera, or a static device, such as a network switch. Edge device 104 and edge device 112 may each have different functions, for example, security, end-user applications, and operating machinery. Edge device 104 and edge device 112 each have a corresponding physical location boundary, i.e., defined, 3D coordinates, in which the edge device is active and responsible for controlling the MR content. Edge device 104 includes MR content control system 106₁ and edge device policy database 110₁. Edge device 112 includes MR content control system 106_{N} and edge device policy database 110_{N}. Edge device 104 and edge device 112 may each include internal and external hardware components, as depicted and described in further detail with respect to computer 301 of FIG. 3.

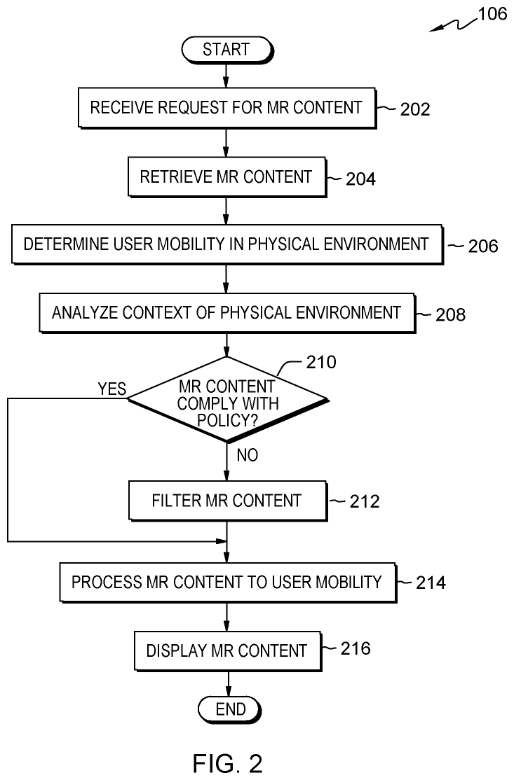

MR content control system 106₁ and MR content control system 106_{N}. herein collectively referred to as MR content control system 106, represent a mixed reality control system resident on a plurality of edge devices. As used herein. N represents a positive integer, and accordingly the number of scenarios implemented in a given embodiment of the present invention is not limited to those depicted in FIG. 1. MR content control system 106 validates and, if necessary, filters MR content prior to displaying the content in order to prevent inappropriate, malicious, and/or misleading content from being displayed to a user. MR content control system 106 receives a request for MR content. MR content control system 106 retrieves the MR content. MR content control system 106 determines the user mobility in the physical environment. MR content control system 106 analyzes the MR context. MR content control system 106 determines whether the MR content complies with a pre-defined policy, and, if not, then MR content control system 106 filters the MR content. MR content control system 106 processes the MR content to the user mobility. MR content control system 106 displays the MR content. MR content control system 106₁ includes context analysis module 108₁. MR content control system 106_{N} includes context analysis module 108_{N}. MR content control system 106 is depicted and described in further detail with respect to FIG. 2.

Context analysis module 108₁ and context analysis module 108_{N}, herein collectively referred to as context analysis module 108, represent a component of MR content control system 106 that analyzes the context of the physical environment in which the user resides when the user requests MR content. As used herein, N represents a positive integer, and accordingly the number of scenarios implemented in a given embodiment of the present invention is not limited to those depicted in FIG. 1. In the depicted embodiment, context analysis module 108 is a standalone component of MR content control system 106. In another embodiment, the function of context analysis module 108 is integrated into MR content control system 106.

Edge device policy database 110₁ and edge device policy database 110_{N}, herein collectively referred to as edge device policy database 110, stores one or more policies associated with each edge device in distributed data processing environment 100, such as edge device 104 and edge device 112. As used herein, N represents a positive integer, and accordingly the number of scenarios implemented in a given embodiment of the present invention is not limited to those depicted in FIG. 1. In the depicted embodiment, edge device policy database 110 resides on each edge device in distributed data processing environment 100. In another embodiment, edge device policy database 110 may reside elsewhere within distributed data processing environment 100, provided that MR content control system 106 has access to edge device policy database 110, via network 102. A database is an organized collection of data. Edge device policy database 110 can be implemented with any type of storage device capable of storing data and configuration files that can be accessed and utilized by MR content control system 106 such as a database server, a hard disk drive, or a flash memory. Edge device policy database 110 stores information used by and generated by MR content control system 106. For example, edge device policy database 110 stores results generated by context analysis module 108 when filtering and/or validating MR content. Edge device policy database 110 also stores 3D coordinates associated with a physical location boundary corresponding to each edge device. Edge device policy database 110 also stores one or more policies associated with the corresponding edge device and/or the physical location boundary associated with the edge device. For example, if the physical environment is a manufacturing facility, then a policy may be authorization to access the facility and/or certain equipment, such as a table saw, within the facility or within the physical location boundary associated with the corresponding edge device. Edge device policy database 110 also stores a user profile of the user of MR device 114. The user profile includes data associated with the user, including, but not limited to, the name of the user, an address, an email address, an image of the user, a voice sample, a phone number, a credit card number, an account number, a business loyalty account number, a student identification number, an employer, a job role, a job family, a business unit association, a job seniority, a job level, a resume, a social network affiliation, a current geographic location, an access credential for MR content, etc.

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails and texts begin with a written notification that the user's information may be recorded or monitored and may be saved, for the purpose of validating and filtering mixed reality content. These embodiments may also include periodic reminders of such recording and monitoring throughout the course of any such use. Certain embodiments may also include regular (e.g., daily, weekly, monthly) reminders to the participating parties that they have consented to being recorded and monitored for validating and filtering mixed reality content and may provide the participating parties with the opportunity to opt-out of such recording and monitoring if desired. Furthermore, to the extent that any non-participating parties' actions are monitored (for example, when outside vehicles are viewed), such monitoring takes place for the limited purpose of providing navigation assistance to a participating party, with protections in place to prevent the unauthorized use or disclosure of any data for which an individual might have a certain expectation of privacy.

MR device 114 can be one or more of a laptop computer, a tablet computer, a smart phone, smart watch, a smart speaker, or any programmable electronic device capable of communicating with various components and devices within distributed data processing environment 100, via network 102. MR device 114 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In an embodiment, the wearable computer may be in the form of a smart watch. In one embodiment, the wearable computer may be in the form of a head mounted display (HMD). The HMD may take the form-factor of a pair of glasses, such as augmented reality (AR) glasses, which is a device for viewing mixed reality and/or augmented reality scenarios. In the embodiment where the HMD is a pair of AR glasses, the AR glasses can capture eye gaze information from a gaze point tracker, such as a camera associated with MR device 114. In general, MR device 114 represents one or more programmable electronic devices or combination of programmable electronic devices capable of executing machine readable program instructions and communicating with other computing devices (not shown) within distributed data processing environment 100 via a network, such as network 102. MR device 114 includes an instance of MR user interface 116.

MR user interface 116 provides an interface between the user of MR device 114 and edge device 104, edge device 112, and server computer 118. In one embodiment, MR user interface 116 is mobile application software. Mobile application software, or an “app,” is a computer program designed to run on smart phones, tablet computers and other mobile devices. In one embodiment, MR user interface 116 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In an embodiment, MR user interface 116 enables a user of MR device 114 to request MR content from MR content database 120. In an embodiment, MR user interface 116 enables a user to store edge device specific policies in edge device policy database 110. In an embodiment, MR user interface 116 also enables the user of MR device 114 to store data associated with a user profile. In an embodiment, MR user interface 116 enables the user of MR device 114 to define physical boundaries associated with each edge device in the physical environment.

Server computer 118 can be a standalone computing device, a management server, a web server, a mobile computing device, or any other electronic device or computing system capable of receiving, sending, and processing data. In other embodiments, server computer 118 can represent a server computing system utilizing multiple computers as a server system, such as in a cloud computing environment. In another embodiment, server computer 118 can be a laptop computer, a tablet computer, a netbook computer, a personal computer (PC), a desktop computer, a personal digital assistant (PDA), a smart phone, an edge device, a containerized workload, or any programmable electronic device capable of communicating with edge device 104, edge device 112, MR device 114, and other computing devices (not shown) within distributed data processing environment 100 via network 102. In another embodiment, server computer 118 represents a computing system utilizing clustered computers and components (e.g., database server computers, application server computers, etc.) that act as a single pool of seamless resources when accessed within distributed data processing environment 100. Server computer 118 includes MR content database 120. Server computer 118 may include internal and external hardware components, as depicted and described in further detail with respect to computer 301 of FIG. 3.

In the depicted embodiment, MR content database 120 resides on server computer 118. In another embodiment, MR content database 120 may reside elsewhere within distributed data processing environment 100, provided that MR content control system 106 and MR device 114 have access to MR content database 120, via network 102. MR content database 120 can be implemented with any type of storage device capable of storing data and configuration files that can be accessed and utilized by MR content control system 106 and MR device 114 such as a database server, a hard disk drive, or a flash memory. MR content database 120 stores MR content for display on MR device 114. For example, the MR content may provide guidance to a user regarding how to navigate from one location to another in a manufacturing facility in order to complete a series of tasks.

The present invention may contain various accessible data sources, such as edge device policy database 110 and MR content database 120, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. MR content control system 106 enables the authorized and secure processing of personal data. MR content control system 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. MR content control system 106 provides information regarding personal data and the nature (e.g., type, scope, purpose, duration, etc.) of the processing. MR content control system 106 provides the user with copies of stored personal data. MR content control system 106 allows the correction or completion of incorrect or incomplete personal data. MR content control system 106 allows the immediate deletion of personal data.

FIG. 2 is a flowchart depicting operational steps of MR content control system 106, on edge device 104 and/or edge device 112 within distributed data processing environment 100 of FIG. 1, for validating and filtering mixed reality content, in accordance with an embodiment of the present invention.

MR content control system 106 receives a request for MR content (step 202). In an embodiment, when a user of MR device 114 begins an MR interaction activity, MR content control system 106 receives a request for MR content. In an embodiment, when the user of MR device 114 requests MR content stored in MR content database 120, via MR user interface 116, MR content control system 106 receives the request. In an embodiment, MR content control system 106 receives the request directly from MR user interface 116. In another embodiment, the request passed to MR content database 120 triggers MR content control system 106 to determine the user has requested MR content. In an embodiment, MR content control system 106 also receives input from MR device 114. For example, input from MR device 114 may include the visual surrounding of the user, the eye gaze of the user, etc.

MR content control system 106 retrieves the MR content (step 204). In an embodiment, MR content control system 106 retrieves the requested MR content from MR content database 120. In another embodiment, in response to the request from the user, MR user interface 116 communicates the request to MR content database 120, MR content database 120 transmits the requested content to MR content control system 106, and MR content control system 106 receives the requested content.

MR content control system 106 determines the user mobility in the physical environment (step 206). In an embodiment, MR content control system 106 tracks the user's interaction in the physical environment and determines the location coordinates and/or relative position of the user and whether the user is moving from one physical location to another. For example, in an embodiment where MR device 114 includes a global positioning service (GPS), MR content control system 106 determines the GPS coordinates of the user as the user moves through the environment. An advantage of tracking the mobility of the user in the environment is that, based on the physical location boundary of each edge device, MR content control system 106 can determine on which edge device to process the requested MR content corresponding to the location of the user. Another advantage of determining the user mobility in the physical environment is to enable edge device 104 and edge device 112 (and any other edge devices in the environment, not shown) to collaborate with each other regarding which instance of MR content control system 106₁-x executes the MR content control process.

MR content control system 106 analyzes the context of the environment (step 208). In an embodiment, MR content control system 106 analyzes the context of the physical environment to determine contextual attributes of the environment. For example, MR content control system 106 may identify a background color, one or more participants in the MR activity, a time of day, etc. In an embodiment, context analysis module 108 analyzes the context of the environment. In an embodiment, MR content control system 106 analyzes the context of the user in the environment. For example, MR content control system 106 determines if the user is an employee that works in the environment. An advantage of analyzing the context of the environment is that while MR content control system 106, as will be discussed below, filters the MR content based on a pre-defined policy, due to the surrounding environment, the MR content may need additional filter.

MR content control system 106 determines whether the MR content complies with a pre-defined policy (decision block 210). In an embodiment, based on the context of the user in the physical environment, MR content control system 106 validates that the requested MR content complies with a pre-defined policy associated with the edge device physical location boundary in which the user currently resides. For example, if the requested MR content includes financial information, the pre-defined policy may be to confirm the user is authorized to view the financial information. In another example, if the requested MR content includes personal information, such as names, the pre-defined policy may be to redact names and replace them with job roles if the user is not authorized to view the names. In an embodiment, each instance of MR content control system 106 in each edge device in the physical environment, simultaneously determines whether the requested MR content complies with each corresponding pre-defined policy.

If MR content control system 106 determines the MR content does not comply with the pre-defined policy (“no” branch, decision block 210), then MR content control system 106 filters the MR content (step 212). In an embodiment, MR content control system 106 filters the requested MR content such that, after being filtered, the content is appropriate and complies with the corresponding pre-defined policy of each edge device. Continuing the previous examples, if the requested MR content includes financial information, and MR content control system 106 determines the user is not authorized to view the financial information, then MR content control system 106 filters out the financial information. Or, if the requested MR content includes personal information, and MR content control system 106 determines the user is not authorized to view the personal information then MR content control system 106 replaces the personal information with generic information. In another example, if MR content control system 106 determines the requested MR content includes malicious and/or misleading content or any content that contains a cyber threat, then MR content control system 106 removes the malicious and/or misleading content. The advantage of filtering the MR content is that MR content control system 106 acts as a security layer and ensures the MR content is in compliance with security policies.

Responsive to filtering the content, or if MR content control system 106 determines the MR content complies with the pre-defined policy (“yes” branch, decision block 210), then MR content control system 106 processes the MR content to the user mobility (step 214). In an embodiment, once MR content control system 106 validates the MR content is in compliance with one or more pre-defined policies associated with the edge device in the physical location in which the user resides, MR content control system 106 processes the MR content to adapt it to various mobility parameters of the user and align the content with the physical environment. For example, if MR content control system 106 determines the user is moving from the physical location boundary of edge device 104 toward the physical location boundary of edge device 112, then MR content control system 106 adapts the MR content from complying with the pre-defined policy of edge device 104 to complying with the pre-defined policy of edge device 112.

In an embodiment, MR content control system 106 leverages intention analysis to identify the intent of the user with respect to interaction with the MR content when processing the MR content for the user. In an embodiment, MR content control system 106 uses historical data associated with how the user, or similar users, have interacted with specific MR content in the past when processing the MR content for the user.

MR content control system 106 displays the MR content (step 216). In an embodiment, MR content control system 106 displays the validated MR content in MR device 114, via MR user interface 116. In another embodiment, MR content control system 106 stores the validated MR content in MR content database 120 and instructs MR device 114 to retrieve the validated content for display to the user.

FIG. 3 is an example diagram of a distributed data processing environment in which aspects of one or more of the illustrative embodiments may be implemented, and at least some of the computer code involved in performing the inventive methods may be executed, in accordance with an embodiment of the present invention, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as MR content control system 106 for validating and filtering MR content. In addition to MR content control system 106, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and MR content control system 106, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in MR content control system 106 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in MR content control system 106 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way. EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more computer processors, a request for mixed reality content from a user;
retrieving, by one or more computer processors, the mixed reality content;
determining, by one or more computer processors, a mobility of the user in a physical environment;
determining, by one or more computer processors, the mixed reality content does not comply with at least one pre-defined policy associated with a physical location boundary within the physical environment;
filtering, by one or more computer processors, the mixed reality content to comply with the at least one pre-defined policy;
based on the mobility of the user in the physical environment, processing, by one or more computer processors, the filtered mixed reality content; and
displaying, by one or more computer processors, the filtered mixed reality content.

2. The computer-implemented method of claim 1, further comprising:
analyzing, by one or more computer processors, a context of the physical environment; and
adapting, by one or more computer processors, the filtered mixed reality content based on the context of the physical environment.

3. The computer-implemented method of claim 2, wherein the context of the physical environment includes at least one of a contextual attribute of the environment and a context of the user in the environment.

4. The computer-implemented method of claim 1, wherein the mobility of the user in the physical environment includes at least one of a location coordinate, a relative position of the user, and whether the user is moving from one physical location to another.

5. The computer-implemented method of claim 1, wherein filtering the mixed reality content to comply with the at least one pre-defined policy further comprises:
removing, by one or more computer processors, at least one of: malicious content, misleading content, personal information, financial information, and information the user is not authorized to view.

6. The computer-implemented method of claim 1, wherein the at least one pre-defined policy associated with the physical location boundary within the physical environment corresponds to an edge computing device.

7. The computer-implemented method of claim 1, wherein processing the filtered mixed reality content further comprises:
identifying, by one or more computer processors, an intent of the user with respect to an interaction with the mixed reality content.

8. A computer program product comprising:
one or more computer-readable storage media;
program instructions, stored on at least one of the one or more computer-readable storage media, to receive a request for mixed reality content from a user;
program instructions, stored on at least one of the one or more computer-readable storage media, to retrieve the mixed reality content;
program instructions, stored on at least one of the one or more computer-readable storage media, to determine a mobility of the user in a physical environment;
program instructions, stored on at least one of the one or more computer-readable storage media, to determine the mixed reality content does not comply with at least one pre-defined policy associated with a physical location boundary within the physical environment;
program instructions, stored on at least one of the one or more computer-readable storage media, to filter the mixed reality content to comply with the at least one pre-defined policy;
based on the mobility of the user in the physical environment, program instructions, stored on at least one of the one or more computer-readable storage media, to process the filtered mixed reality content; and
program instructions, stored on at least one of the one or more computer-readable storage media, to display the filtered mixed reality content.

9. The computer program product of claim 8, further comprising:
program instructions, stored on at least one of the one or more computer-readable storage media, to analyze a context of the physical environment; and
program instructions, stored on at least one of the one or more computer-readable storage media, to adapt the filtered mixed reality content based on the context of the physical environment.

10. The computer program product of claim 9, wherein the context of the physical environment includes at least one of a contextual attribute of the environment and a context of the user in the environment.

11. The computer program product of claim 8, wherein the mobility of the user in the physical environment includes at least one of a location coordinate, a relative position of the user, and whether the user is moving from one physical location to another.

12. The computer program product of claim 8, wherein the program instructions to filter the mixed reality content to comply with the at least one pre-defined policy further comprise:
program instructions, stored on at least one of the one or more computer-readable storage media, to remove at least one of: malicious content, misleading content, personal information, financial information, and information the user is not authorized to view.

13. The computer program product of claim 8, wherein the at least one pre-defined policy associated with the physical location boundary within the physical environment corresponds to an edge computing device.

14. The computer program product of claim 8, wherein the program instructions to process the filtered mixed reality content further comprise:
program instructions, stored on at least one of the one or more computer-readable storage media, to identify an intent of the user with respect to an interaction with the mixed reality content.

15. A computer system comprising:
one or more computer processors;
one or more computer-readable memories; and
one or more computer-readable storage media;
program instructions, stored on at least one of the one or more computer-readable storage media for execution by at least one of the one or more computer processors via at least one of the one or more memories, to receive a request for mixed reality content from a user;
program instructions, stored on at least one of the one or more computer-readable storage media for execution by at least one of the one or more computer processors via at least one of the one or more memories, to retrieve the mixed reality content;
program instructions, stored on at least one of the one or more computer-readable storage media for execution by at least one of the one or more computer processors via at least one of the one or more memories, to determine a mobility of the user in a physical environment;
program instructions, stored on at least one of the one or more computer-readable storage media for execution by at least one of the one or more computer processors via at least one of the one or more memories, to determine the mixed reality content does not comply with at least one pre-defined policy associated with a physical location boundary within the physical environment;
program instructions, stored on at least one of the one or more computer-readable storage media for execution by at least one of the one or more computer processors via at least one of the one or more memories, to filter the mixed reality content to comply with the at least one pre-defined policy;
based on the mobility of the user in the physical environment, program instructions, stored on at least one of the one or more computer-readable storage media for execution by at least one of the one or more computer processors via at least one of the one or more memories, to process the filtered mixed reality content; and
program instructions, stored on at least one of the one or more computer-readable storage media for execution by at least one of the one or more computer processors via at least one of the one or more memories, to display the filtered mixed reality content.

16. The computer system of claim 15, further comprising:
program instructions, stored on at least one of the one or more computer-readable storage media for execution by at least one of the one or more computer processors via at least one of the one or more memories, to analyze a context of the physical environment; and
program instructions, stored on at least one of the one or more computer-readable storage media for execution by at least one of the one or more computer processors via at least one of the one or more memories, to adapt the filtered mixed reality content based on the context of the physical environment.

17. The computer system of claim 16, wherein the context of the physical environment includes at least one of a contextual attribute of the environment and a context of the user in the environment.

18. The computer system of claim 15, wherein the program instructions to filter the mixed reality content to comply with the at least one pre-defined policy further comprise:
program instructions, stored on at least one of the one or more computer-readable storage media for execution by at least one of the one or more computer processors via at least one of the one or more memories, to remove at least one of: malicious content, misleading content, personal information, financial information, and information the user is not authorized to view.

19. The computer system of claim 15, wherein the at least one pre-defined policy associated with the physical location boundary within the physical environment corresponds to an edge computing device.

20. The computer system of claim 15, wherein the program instructions to process the filtered mixed reality content further comprise:
program instructions, stored on at least one of the one or more computer-readable storage media for execution by at least one of the one or more computer processors via at least one of the one or more memories, to identify an intent of the user with respect to an interaction with the mixed reality content.
